(19) United States
(12) Patent Application Publication
(10) Pub. No.: US 2020/0368941 A1
(43) Pub. Date: Nov. 26, 2020

(54) SHAPING DEVICE, SHAPING MOULD WITH A PART TO BE FORMED AND METHOD FOR HEATING A SHAPING SURFACE OF A SHAPING HALF-SHELL OR OF A PART TO BE FORMED

(71) Applicants: RAMPF Holding GmbH & Co. KG, Grafenberg (DE); RAMPF Machine Systems GmbH & Co. KG, Wangen (DE)

(72) Inventors: Thomas Abel, Uhingen (DE); Marc Dizdarevic, Uhingen (DE); Gerd-Sebastian Beyerlein, Metzingen (DE)

(21) Appl. No.: 16/767,525

(22) PCT Filed: Nov. 19, 2018
(86) PCT No.: PCT/EP2018/081761

§ 371 Date: May 27, 2020

(30) Foreign Application Priority Data
Nov. 27, 2017 (DE) 10 2017 221 152.0

(51) Int. Cl. B29C 33/06; B29C 33/38; B29C 37/00; B29C 33/56; B29C 35/08

(52) U.S. Cl. CPC B29C 33/06; B29C 33/38; B29C 37/00; B29C 33/56; B29C 2037/90; B29K 2909/06; B29K 2905/00; B29C 2035/0816; B29K 2995/0005; B29C 35/0805

(57) ABSTRACT

The invention relates to a shaping device (10), which comprises an inductor (14) and one or more shaping half-shells (12, 34), wherein at least one shaping half-shell (12, 34) comprises a bottom shaping element (16) produced from mineral material, and a top shaping element (17), wherein the top shaping element (17) is releasably connected to the bottom shaping element (16) or is formed integrally with it, covers at least parts of an inner surface (16a) of the bottom shaping element (16) and comprises an electrically conductive layer (18), and the inductor (14) is designed to induce eddy currents in the electrically conductive layer (18). The invention further relates to a shaping mould (40) with a part to be formed (38), as well as to a method for heating a shaping surface (17a) of a top shaping element (17) of a shaping half-shell (12, 34) or a shaping surface (38a) of a part to be formed (38).

The invention relates to a shaping device which can be used, for example, for the production of plastic components and/or plastic-based fiber composite components, a shaping mould with a part to be formed and a method for heating a shaping surface of a shaping half-shell or a part to be formed.

In the manufacture of plastic components and/or plastic-based fiber composite components, a casting material (e.g., a polymer or a matrix polymer) is placed in a shaping half-shell in which a fiber and/or a fabric structure and/or prepregs can be stored. The casting material can either be melted before being cast into the shaping half-shell or within the shaping half-shell. In both cases, it is crucial for the desired properties of the finished component to be achieved that the casting material completely fills the shaping half-shell and, if present, completely infiltrates the fiber and/or the fabric structure. To ensure this, it is necessary for the casting material in the shaping half-shell to be in a melted and flowable state at least for a predetermined period of time. For this purpose, the casting material must be exposed to heat during this period. After this time has elapsed, curing can take place by cooling the casting material in the shaping half-shell, as a result of which the plastic component and/or the plastic-based fiber composite component is produced. Alternatively, a preform and/or a shape-related semi-finished product (e.g., a mat made of nonwoven with plastic/glass parts) can also be used for the production of plastic components or plastic-based fiber composite components.

This means that, in the production of plastic components and/or plastic-based fiber composite components, a method step in which high temperatures are required is followed by a further method step in which low temperatures are required. A shaping mould for the production of plastic components and/or plastic-based fiber composite components should therefore be suitable for enabling rapid heating and cooling of the casting material and/or preform and/or for the shape-related semi-finished product required for production, and should have a very precisely mouldable shaping surface in order to provide a negative shape having fine structures for the plastic component or plastic-based fiber composite component to be manufactured. Furthermore, the shaping mould should also have very good stability in series production. This includes, for example, that the shaping surface has an essentially constant surface quality.

Conventional shaping moulds that meet these requirements typically consist of metallic materials, for example a metal block with a negative structure formed therein. In the method steps in which tempering is necessary, the entire metallic material and/or the entire metal block is tempered, i.e., heated and/or cooled. This leads to long warm-up and cooling times and an associated long process time, which in turn is disadvantageous from the point of view of an efficient manufacturing process.

It is therefore the object of the invention to provide a shaping device by means of which plastic components and/or plastic-based fiber composite components can be produced more efficiently and economically.

This object is achieved according to the invention by a shaping device which comprises an inductor and one or more shaping half-shells, at least one shaping half-shell comprising a bottom shaping element made of mineral material and a top shaping element, the top shaping element being releasably connected to or integrally formed with the bottom shaping element, an inner surface of the bottom shaping element is covered at least in sections and comprises an electrically conductive layer, and the inductor is configured to induce eddy currents in the electrically conductive layer.

The induced eddy currents cause the electrically conductive layer to heat up within a few seconds. This heat can thus be transferred directly and locally to a casting material (e.g., a polymer or matrix polymer) or a preform and/or a shape-related semi-finished product (e.g., a mat made of nonwoven with plastic/glass components), which contacts the electrically conductive layer during a moulding process. In this way, as much heat can be generated as is required for the desired shaping process. A heat conduction through the entire body of the shaping half-shell, as is the case with conventional processes, is consequently not necessary. Even arranging the inductor at a distance from the electrically conductive layer does not lead to an increase in the process time, since the magnetic field generated by the inductor, for example, can penetrate the mineral material of the bottom shaping element and/or the top shaping element, air or other non-inducible materials almost without loss. A shaping device according to the invention with the electrically conductive layer inducible by the inductor can thus lead to short process times and a more favorable energy balance, and an associated increase in the economy of the shaping process. In addition, the electrically conductive layer can specifically cover areas of the shaping surface that are to be heated. Furthermore, if the casting material has constituents and/or additives that can be excited by the inductor, for example graphite particles, the casting material can be heated even more quickly. The shaping device according to the invention thus contributes to making shaping processes of the type mentioned, in which the shaping device according to the invention is used, cheaper, faster and more flexible.

In addition, mineral materials are less expensive than metallic materials, so that their use according to the invention for the bottom shaping element of the at least one shaping half-shell can also lead to greater economy of a shaping process in which the shaping device according to the invention is used. Furthermore, the processing of mineral materials is much cheaper than that of metallic materials. At the same time, it is possible to reproduce fine structures in mineral materials with high accuracy, for example by curing the mineral material in a casting mould.

Furthermore, the lower thermal conductivity of mineral materials compared to metallic materials favors their use as the bottom shaping element of the at least one shaping half-shell, since the thermal energy penetrating into the bottom shaping element and consequently stored therein is low. That is, an extension of the process time in the case of a process-related temperature change due to thermal energy stored in the bottom shaping element is small in comparison to conventional shaping moulds made of metallic material. For the temperature change required during a shaping process, comparatively little time and little energy is therefore required when using the shaping device according to the invention.

In the case of a releasable connection between the bottom shaping element and the top shaping element, for example the top shaping element, which as a rule is specially adapted to the plastic component and/or plastic-based fiber composite component to be manufactured, can be exchanged after production with another top shaping element, which is specially adapted to another plastic component and/or plastic-based fiber composite component to be manufactured. The bottom shaping element with all of its functional units, such as the inductor, a sensor (explained in more detail below) or a temperature control device (explained in more detail below) is therefore advantageously not subject to a tool change. The division of the shaping half-shell into the bottom shaping element and the top shaping element and the releasable connection of these elements can therefore lead to a further cost reduction of the shaping device compared to conventional shaping devices.

The mineral material can be a polymer concrete, preferably with high heat resistance. A polymer concrete differs from conventional concrete in that not a cement but a plastic is used as a binding agent to hold the mineral components together. Particularly high mechanical strengths are achieved, the lower the proportion of binder, since with a low proportion of binder, the force transfer takes place mainly from rock to rock and only through a boundary layer of plastic. The mass fraction of plastic is preferably 10 wt % to 15 wt % in the finished concrete, or even less than 10 wt % in the finished concrete, preferably 7 wt % in the finished concrete. Particularly low proportions of plastic can be achieved if a pack that is as dense as possible is produced in the dry state and each granule is then wetted. The advantages of polymer concrete are, for example, that it is particularly pressure and bending tensile resistant compared to normal cement concrete, has good dimensional stability and high abrasion resistance, and its thermal expansion coefficient is of the order of magnitude of steel.

The mineral material can advantageously also be Ultra High Performance Concrete (UHPC). Ultra High Performance Concrete is particularly well suited because it can be used to map fine structures with a very high level of accuracy. Furthermore, it is self-compacting, so that the processing process incurs low energy costs. A possible Ultra High Performance Concrete can be, for example, EPUDUR, a brand of RAMPF Maschinensysteme GmbH & Co. KG, which also has the aforementioned advantages and is particularly longterm stable thanks to innovative accuracy and adhesive technologies.

Another advantage of mineral materials, such as polymer concrete or UHPC, is that they can be cast into the desired shape using a casting process and functional components can be cast directly into them during the casting process or corresponding cavities can be kept free, which can be set up for this to include functional components. In this way, the shaping device can be made very compact and at the same time the functional components can be protected from external influences. In a preferred embodiment, for example, the inductor, as an example of such a functional component, is arranged in the bottom shaping element, preferably cast into it.

The electrically conductive layer is advantageously encompassed by the top shaping element in such a way that it is formed in a shape that is essentially complementary to the finished plastic component and/or plastic-based fiber composite component. It is therefore advantageous if the conductive layer comprises a mouldable material for forming a surface contour or if it can map the structure of the shaping surface. The electrically conductive layer can be, for example, a sheet metal or a metal layer applied to the top shaping element at least in sections, for example by sputtering on a metal powder. It is also possible for the electrically conductive layer to be formed from an electrically non-conductive material with electrically conductive elements arranged therein, for example electrically conductive particles and/or electrically conductive fibers. Furthermore, alternatively or additionally, electrically conductive elements, for example electrically conductive particles (e.g., graphite particles) and/or electrically conductive fibers, can be arranged in the top shaping element, adjacent to a shaping surface of the top shaping element. In a further alternative embodiment, electrically conductive elements, for example electrically conductive particles and/or electrically conductive fibers, can be embedded in the top shaping element adjacent to the shaping surface.

In order to increase the durability of the shaping device and thus also to improve the economy of a shaping process using the shaping device, the electrically conductive layer of the top shaping element and/or the shaping surface of the top shaping element can have a protective layer. The protective layer can protect against abrasion and/or surface changes, for example through the use of cleaning agents or other solvents. The protective layer can be a ceramic layer, preferably a cold-hardening ceramic layer, which can also have the advantage that it does not interfere with the inductances. Furthermore, the protective layer can also be a high-performance plastic, for example polytetrafluoroethylene (PTFE).

In order to achieve the most compact and simple structure of the shaping device, it can be provided that the electrically conductive layer and the protective layer are one and the same layer. For example, a sheet can act as an electrically conductive layer and a protective layer at the same time.

As is known, pore water is found in hydraulically bound materials, for example UHPC, which pore water, when heated, causes an increase in pressure and the associated stresses within the mineral material. The result can be damage to the mineral material, for example due to the formation of cracks. One way to avoid such damage in the bottom shaping element made of mineral material is to limit undesirable temperature increases within the mineral material to less than about 150° C., preferably less than about 100° C. To monitor the bottom shaping element and to avoid damaging the bottom shaping element, a sensor, for example at least a temperature sensor and/or humidity sensor and/or pressure sensor and/or voltage sensor, can be arranged in the bottom shaping element, preferably cast into it. Alternatively or additionally, a sensor, for example at least one of the aforementioned sensors, can also be arranged in the top shaping element, preferably cast into it. It is understood that this can increase the life of the shaping device.

In an embodiment of the invention, the bottom shaping element, for example in order to avoid undesirable temperature increases, can further comprise a temperature control device which can either be arranged adjacent to an outer surface of the bottom shaping element facing away from the inner surface and/or can be arranged in the volume of the bottom shaping element, preferably can be cast into the latter. By means of this temperature control device, said temperature fluctuations in the bottom shaping element can be avoided, which can lead to stresses and, in the worst case, also cracks in the interior of the bottom shaping element. The service life of the shaping device can thus be increased by means of the temperature control device.

Furthermore, an undesirable temperature increase in the bottom shaping element can be avoided and/or reduced by reducing and/or avoiding heat conduction starting from the electrically conductive layer in the direction of the bottom shaping element. This can be achieved, for example, in that the mineral material from which the bottom shaping element is made preferably comprises at least one additive that reduces the thermal conductivity of the mineral material. Such additives can be, for example, an aerogel based on silicon dioxide (SiO₂) or silicon carbide (SiC) or another additive with a low thermal conductivity. Materials with reduced and/or low thermal conductivity are understood to be those which have a thermal conductivity A, the value of which is less than 2 W/mK, preferably less than 1 W/mK, more preferably less than 0.2 W/mK.

Additionally or alternatively, the heat conduction starting from the electrically conductive layer can be reduced by preferably arranging a heat-insulating layer between the bottom shaping element and the top shaping element and/or in the bottom shaping element and/or in the top shaping element. All materials which have a low thermal conductivity, such as cellulose, and/or which have a porous structure, for example an aerogel skeleton, can be used as material for the heat-insulating layer. The heat-insulating layer preferably comprises only materials in which no heat-generating eddy currents which can be induced by the inductor are produced. The heat-insulating layer can be an insulation mat, for example. It is also conceivable that the heat-insulating layer can comprise one or more insert bodies, of which at least one preferably forms a cavity. A gas enclosed in the cavity, for example air, can in this case serve as a heat insulator. Suitable insert bodies are, for example, those which have a honeycomb structure and/or a structure of a corrugated paper, it being possible for the insert body to comprise the materials mentioned above in relation to the heat-insulating layer. The value of the thermal conductivity λ of such a layer can be less than 2 W/mK, preferably less than 1 W/mK, more preferably less than 0.2 W/mK. In general, the heat-insulating layer, particularly if it has a structure with at least one gas-filled cavity formed therein, can advantageously lead to a reduction in the weight of the shaping half-shell. This in turn facilitates handling of the shaping half-shell and thus has a positive effect on process times and thus also on process costs.

The heat insulating layer may preferably comprise a preceramic paper. A preceramic paper in the context of the present invention is understood to be a paper into which special fillers, such as silicon and/or aluminum, have already been introduced during the manufacture of the paper. A preceramic paper can be in a wide variety of shapes, different sizes and shapes, similar to a sheet of paper, as a result of which it can be adapted very well to the shape of the respective bottom shaping element and/or top shaping element. Furthermore, the preceramic paper can be folded, corrugated and/or layered, for example. This has the advantage that a structural thermal decoupling between layers directly or indirectly adjacent on opposite sides of the preceramic paper can be set and/or changed in a targeted manner depending on the present shape of the preceramic paper. In this way, the use of a preceramic paper can protect the bottom shaping element made of a mineral material from damage due to excessive temperatures. In particular, the use of preceramic paper as a heat-insulating layer can be provided if the mineral material of the bottom shaping element is polymer concrete. It goes without saying that the polymer concrete can also be protected from damage by adapting the process parameters, such as pressure and temperature.

For example, the top shaping element can be essentially, preferably over 80%, made of a metallic material and the heat-insulating layer can be arranged between the bottom shaping element and the top shaping element or can be integrally formed with one of the two elements. In this way, the shaping surface can for example be produced on a metallic material using conventionally known methods. At the same time, the proportion of metallic material—with the disadvantages mentioned in the introductory section—can be relatively small. Alternatively or additionally, the top shaping element can further comprise a mineral material. For example, the top shaping element could have a layer structure with a mineral layer, an optional cooling element (as described below) and/or an optional heat-insulating layer and a metallic, electrically conductive layer.

An undesirable temperature increase can also be avoided or reduced in the top shaping element and thus indirectly in the bottom shaping element by reducing and/or avoiding heat conduction starting from the electrically conductive layer in the direction of an interior of the top shaping element. This can be achieved, for example, in that the mineral material from which the top shaping element is made preferably comprises at least one additive which reduces the thermal conductivity of the mineral material. Such additives can be, for example, an aerogel based on silicon dioxide (SiO₂) or silicon carbide (SiC) or another additive with a low thermal conductivity. Materials with reduced and/or low thermal conductivity are understood to be those which have a thermal conductivity λ, the value of which is less than 2 W/mK, preferably less than 1 W/mK, more preferably less than 0.2 W/mK.

Instead of or in addition to the heat-insulating layer, the top shaping element can further comprise a cooling element, which is preferably arranged on and/or adjacent to the electrically conductive layer. The cooling element can preferably have a cooling layer and/or a cooling structure. The cooling structure can, for example, be meandering and/or have cooling lines adapted to the shaping surface and/or to the electrically conductive layer. The cooling element can be configured to protect the top shaping element and thus indirectly also the bottom shaping element from undesired temperature changes and/or to actively cool the shaping surface and/or the electrically conductive layer. For example, if the inductor does not generate eddy currents in the electrically conductive layer, it can be cooled very quickly, preferably within a few seconds, by means of the cooling element.

As an alternative or in addition to the heat-insulating layer and/or the cooling element, the shaping device can comprise a heat pipe. A heat pipe is understood to be a heat exchanger by means of which quantities of heat can be transported. As is known, a distinction is made between two types, the heat pipe and the two-phase thermosiphon. The heat pipe usually comprises a hermetically decoupled volume in which there is a working medium, for example water or ammonia. When heat is introduced into the heat pipe, the working medium is evaporated to a point at a lower temperature at which it condenses and emits heat of condensation. With a two-phase thermosiphon, the cooled working medium is returned by gravity or, in the case of a heat pipe, by capillary forces. When choosing the suitable heat pipe, the positioning of the shaping device must therefore be observed. For example, an upper shaping half-shell could comprise a two-phase thermosiphon, and a lower shaping half-shell could comprise a heat pipe. Furthermore, both shaping half-shells could also comprise a heat pipe. It is clear that a plurality of heat pipes can also be arranged at least partially within the shaping element.

The heat pipe can be at least partially arranged in the bottom shaping element, for example cast into it. One end of the heat pipe is preferably arranged on and/or adjacent to the electrically conductive layer. It is also conceivable that another end of the heat pipe points away from the electrical layer. For example, the other end could protrude from the shaping half-shell and/or be actively cooled and/or be arranged on and/or adjacent to the temperature control device. The heat pipe can advantageously remain in the bottom shaping element even when the top shaping element is changed. Consequently, it is not necessary to adapt the heat pipe to a corresponding shape of the top shaping element.

Furthermore, a contact element, preferably a plate contact, can be cast into the bottom shaping element, which is in contact with the conductive layer when the bottom shaping element is connected to the top shaping element, and transfers heat from the conductive layer to the heat pipe.

The heat pipe is preferably arranged in such a way that heat transfer between the inductor and the heat pipe does not take place or scarcely takes place. Furthermore, the heat pipe should not contain any elements that can be excited by the inductor.

In a further development of the invention it is proposed that, for example, at least one of the bottom shaping element or the top shaping element of one of the shaping half-shells is surrounded by a frame, on which guide elements can preferably be arranged. For example, brackets for transporting or opening the shaping device can be arranged on the frame or the frame can be designed to transmit loads. The frame is preferably arranged in such a way that the inductor cannot generate eddy currents in the frame that may lead to heating and/or only to negligibly slight heating. In addition, an insulating material can be arranged between the inductor and the frame in order to reduce or even avoid induction of eddy currents within the frame by the inductor. Possible insulating materials are, for example, an aerogel having an organic or inorganic base, an aerogel composite material having an organic or inorganic base, a rigid foam with low conductivity, or another polymer material with low conductivity.

In one embodiment of the invention, the shaping device comprises exactly two shaping half-shells, which can preferably be arranged opposite one another, but can have a different shape, in particular a differently shaped shaping surface shape. The two shaping half-shells can be joined so tightly that a cavity is formed between them, which cavity is preferably designed to be completely filled with casting material.

Each of the shaping half-shells can be designed according to the features mentioned above. For example, the inductor may only be arranged in the bottom shaping element of the first shaping half-shell, preferably cast into it, while the second shaping half-shell is free of inductors. However, the inductor of the first shaping half-shell may be configured to induce eddy currents which generate heat both in the electrically conductive layer of the first and in the second shaping half-shell. Furthermore, in the event that each shaping half-shell has an inductor, independent control of the two inductors is conceivable. This can be advantageous, for example, if a preform and/or a shape-related semi-finished product is to be formed, the top and bottom of which are made of different materials or which have different covers, for example a nonwoven cover on the component side and a functional plastic film on the back of the component.

According to a further aspect, the invention comprises a shaping mould with a part to be formed, the shaping mould comprising an inductor and one or more shaping half-shells, at least one shaping half-shell comprising an element made of a mineral material, preferably a bottom shaping element as described above, in which case the part to be formed comprises an electrically conductive layer which at least partially covers a shaping surface of the part to be formed, the inductor of the shaping mould being set up to induce eddy currents in the electrically conductive layer of the part to be formed.

In the same manner, the advantages in relation to the shaping device mentioned above result. Therefore, the manufacture of plastic components and/or plastic-based fiber composite components is made more efficient and economical by means of the aforementioned shaping mould with a part to be formed.

In particular, with the shaping mould according to the invention, a part to be formed can be heated even more quickly with a part to be formed, for example a preform and/or shape-related semi-finished product, since the heating takes place directly on the part to be formed and thermal output only takes place directly on the part to be formed.

According to a further aspect, the invention comprises a method for heating a shaping surface of a top shaping element of a shaping half-shell, preferably a top shaping element of a previously described shaping device, or a shaping surface of a part to be formed, preferably a part of a shaping mould as previously described, the shaping surface of the shaping half-shell or the part to be formed is heated by means of an inductor which induces eddy currents in an electrically conductive layer arranged adjacent to the shaping surface.

In the same manner, the advantages mentioned above in relation to the shaping device result. Therefore, the production of plastic components and/or plastic-based fiber composite components is made more efficient and economical by means of the aforementioned method.

In general, a shaping device, preferably a previously described shaping device, can be used in a shaping process which preferably comprises the following steps:

Step 1: Introducing a casting material or a preform and/or a shape-related semi-finished product (e.g., a mat made of nonwoven with plastic/glass parts) into a shaping half-shell in which, for example, a fiber and/or fabric structure and/or a prepreg can be stored,

Step 2: Closing the shaping half-shell, for example with another shaping half-shell,

Step 3: Heating a shaping surface of a top shaping element of the shaping half-shell or a part to be formed by means of an inductor, which induces eddy currents in an electrically conductive layer arranged adjacent to the shaping surface, and reshaping under pressure of the casting material or the preform and/or the shape-related semi-finished product,

Step 4: Cooling the formed casting material and/or the formed preform and/or the formed semi-finished product, and

Step 5: Removing the plastic component and/or plastic-based fiber composite component from the shaping half-shell(s),

in which case step 2 can take place before step 1 when using casting material.

The invention will be explained in more detail below using two exemplary embodiments with reference to the accompanying drawings. In the drawings:

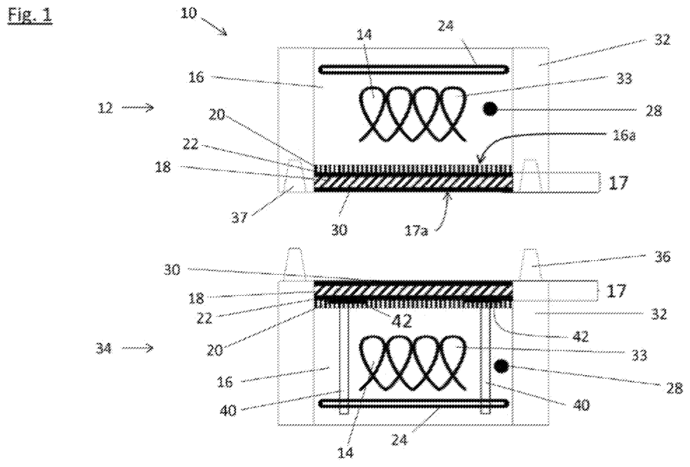

FIG. 1 is a schematic representation of the cross section of a shaping device according to the invention according to a first embodiment;

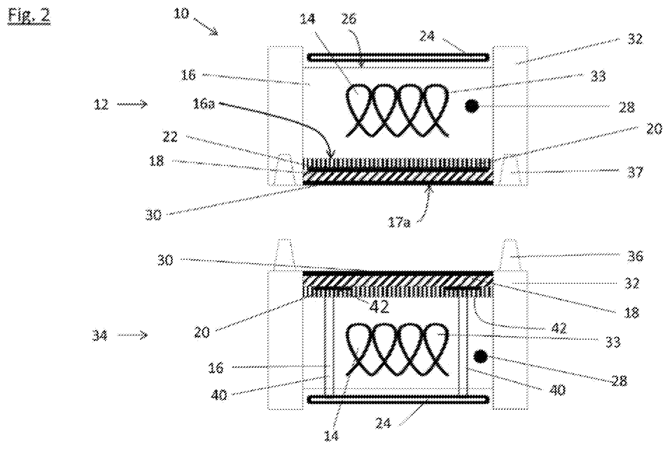

FIG. 2 is a schematic representation of the cross section of a shaping device according to the invention according to a second embodiment;

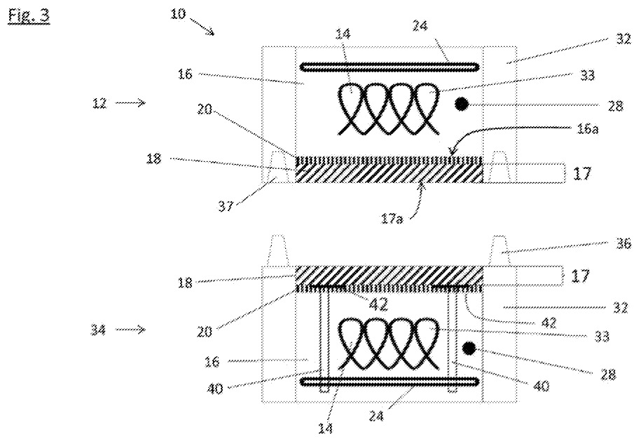

FIG. 3 is a schematic representation of the cross section of a shaping device according to the invention according to a third embodiment; and

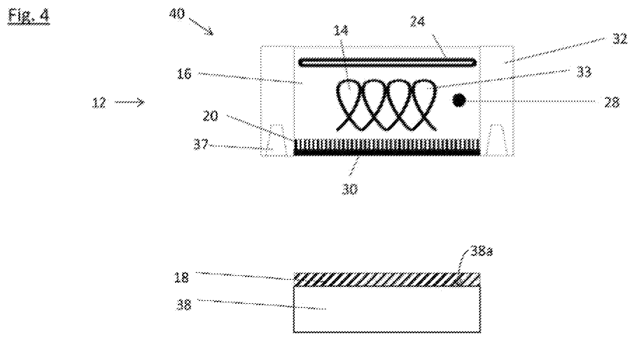

FIG. 4 is a schematic representation of the cross section of a shaping mould according to the invention with a part to be formed according to an embodiment.

In FIG. 1, a shaping device is generally designated with the number 10. The shaping device 10 comprises at least a first shaping half-shell 12 and an inductor 14. The shaping half-shell 12 comprises a bottom shaping element 16 made of mineral material and a top shaping element 17, on the shaping surface 17a of which an electrically conductive layer 18 can be arranged which covers the shaping surface 17a of the top shaping element 17, at least in sections. The top shaping element 17 is releasably connected to the bottom shaping element 16 or is formed integrally with it. The top shaping element 17 covers an inner surface 16a of the bottom shaping element 16 at least in sections and comprises an electrically conductive layer 18. The inductor 14, which, for example and as shown in the exemplary embodiments in FIGS. 1 and 2, can be embedded as an inductor coil 33 in the bottom shaping element 16, is configured to induce eddy currents in the electrically conductive layer 18, whereupon the latter heats up. The electrically conductive layer 18 can either be made of a ceramic layer provided with conductive particles, such as graphite, or it can be a metallic layer or a layer made of another suitable material in which eddy currents can be generated. An embodiment is also conceivable in which the inductor 14 is arranged outside the bottom shaping element 16, or even outside the shaping half-shell 12, 34.

In order to avoid heat loss of the heat generated in the electrically conductive layer 18 and/or excessive heating of the top shaping element 17 or the bottom shaping element 16, it is desirable to as far as possible prevent or at least reduce heat radiation in the direction of an interior of the top shaping element 17 or in the direction of the bottom shaping element 16 of the first shaping half-shell 12. This can be done, for example, by a layer structure of the first shaping half-shell 12, by means of which thermal decoupling is provided between the electrically conductive layer 18 and one or more layers of the top shaping element 17 or between the top shaping element 17 and the bottom shaping element 16.

A possible decoupling is enabled by arranging a heat-insulating layer 20 in the top shaping element 17, which is adjacent to the electrically conductive layer 18 or between the top shaping element 17 and the bottom shaping element 16. Alternatively, the heat-insulating layer can also be arranged in the bottom shaping element 16, for example being cast into the bottom shaping element 16 during the production process. For example, a thermally low-conductive insulation material, for example in the form of a mat, can be used as the heat-insulating layer 20. This could already be introduced during the casting process for producing the bottom shaping element 16 and/or the top shaping element 17. In this context, a heat-insulating layer 20 with a thin honeycomb or corrugated cardboard structure appears to be particularly advantageous, since these can have a gas-filled and/or porous structure, which acts as an insulator. If this honeycomb or corrugated sheet structure is also itself made of a material with low thermal conductivity, such as cellulose, and/or has a microporous structure, such as an aerogel scaffold, thermal insulation, which has no or only a slight negative effect on the mechanical strength of the bottom shaping element 16 and/or the top shaping element 17, can be achieved. Materials and/or layers with reduced or low thermal conductivity are understood to be those which have a thermal conductivity A, the value of which is less than 2 W/mK, preferably less than 1 W/mK, more preferably less than 0.2 W/mK.

During a moulding process, for example for the production of plastic-based fiber composite components, a method step in which the casting material is melted and heated is followed by a further method step in which the casting material is cooled and solidifies. This means that it is necessary for the electrically conductive layer 18 to cool down again after it has been warmed up in a first method step. Such cooling can, on the one hand, take place passively in that eddy currents are no longer generated in the electrically conductive layer 18 by means of the inductor 14. On the other hand, however, active cooling is also possible by means of a cooling element 22, which can be arranged on the electrically conductive layer 18 or can be adjacent to it.

The cooling element 22 can be a cooling coil, for example, which is set up to actively cool at least part of the electrically conductive layer 18. If the shaping device 10 comprises both a heat-insulating layer 20 and a cooling element 22, the cooling element 22 can preferably be arranged between the electrically conductive layer 18 and the heat-insulating layer 20. Methods for applying such a cooling structure and a metal layer formed there from a metal powder, which can be, for example, the electrically conductive layer 18, are already part of the prior art.

In addition or as an alternative to the heat-insulating layer 20 and/or the cooling element 22, the first shaping half-shell 12 can comprise a temperature control device 24, which is either arranged in the volume of the bottom shaping element 16, as shown in FIGS. 1 and 3, and/or is arranged adjacent to a surface 26 facing away from the shaping surface, as shown in FIG. 2. Regardless of its arrangement, the temperature control device 24 can be set up to reduce or even prevent heating of the bottom shaping element 16.

A status of the bottom shaping element 16 and/or the top shaping element can be monitored, for example, by arranging at least one sensor 28 therein, wherein the at least one sensor 28 can be a temperature sensor and/or humidity sensor and/or pressure sensor and/or voltage sensor. The at least one sensor 28 may have been cast into the bottom shaping element 16 and/or the top shaping element 16 during the casting process.

In general, a functionalisation of the bottom shaping element 16 by casting in components during the casting process of the bottom shaping element 16, for example casting in the at least one sensor 28 and/or the temperature control device 24, offers the possibility of passive monitoring and also active control of forming-relevant parameters, which can be determined with one of the aforementioned sensors 28 or can be calculated on the basis of the values measured using one of these, for example a temperature of the bottom shaping element 16, an internal pressure in the bottom shaping element 16, a tension in the bottom shaping element 16, etc.

Likewise, the top shaping element 17 can also be functionalised if at least one sensor 28 or the cooling element 22 is arranged therein, for example in the case of a top shaping element 17 made of a mineral material by casting. For example, the temperature of the electrically conductive layer 18 and/or the top shaping element 17 can be monitored by means of a temperature sensor.

Furthermore, a protective layer 30 can cover the electrically conductive layer 18 and/or the shaping surface of the top shaping element 17. The protective layer 30 can be provided in order to protect against abrasion. Furthermore, this can have a desired structure and/or a desired roughness. The protective layer 30 can be set up in such a way that a cast material and/or a preform and/or a shape-related semi-finished product can be in contact with it during a shaping process. The protective layer 30 may further reduce or even prevent material from adhering during the moulding process.

The shaping half-shell 12 can be provided with a frame 32 in which, for example, guide elements of the shaping device 10 can also be located. The frame 32 can be responsible for the load transfer and is preferably outside the actual forming environment, i.e., preferably does not form a shaping surface and preferably has no electrically conductive layer.

FIG. 3 shows an exemplary embodiment in which the top shaping element 17 can be formed from a metallic material 19. The top shaping element 17 made of a metallic material can in this case form both the shaping surface 17a and the electrically conductive layer 18, and said element can optionally comprise a protective layer 30. Any heat transfer from the top shaping element 17 to the bottom shaping element 16 can be reduced or even prevented by arranging a heat-insulating layer 20 between the top shaping element 17 and the bottom shaping element 16. The heat-insulating layer 20 can be formed by a preceramic paper which is stacked, for example, from several layers, which can be corrugated or folded or flat, for example.

The shaping device 10, as can be seen in FIGS. 1 to 3, can comprise a second shaping half-shell 34 in addition to the first shaping half-shell 12. The first and the second shaping half-shells 12, 34 can be arranged opposite one another so that a cavity can be formed between them, which can be configured to be filled with casting material during a shaping process, preferably to be filled completely. The frame 32 of one of the shaping half-shells 12 or 34 can have at least one positioning projection 36, while the respective other shaping half-shell 34 or 12 has a positioning recess 37 which is complementary and cooperates therewith, so that an exact positioning of the shaping half-shells 12, 34 relative to one another can be achieved.

The second shaping half-shell 34 can comprise one, more, or all of the functional components that have been described above with reference to the first shaping half-shell 12, for example a bottom shaping element 16 made of mineral material with an inductor 14, at least one sensor 28 and a temperature control device 24, a top shaping element 17 comprising an electrically conductive layer 18, a cooling element 22 and a protective layer 30, a heat-insulating layer 20 between the bottom shaping element 16 and the top shaping element 17 and/or a frame 32.

If both shaping half-shells 12, 34 have an inductor 14 and an electrically conductive layer 18, a cast material located between them or a preform and/or a shape-related semi-finished product can be heated on both sides, homogeneously and very quickly.

Alternatively, the second shaping half-shell 34 could be formed without an inductor and/or without an electrically conductive layer, but could have a top shaping element 17 with a cooling element 22 and/or a bottom shaping element 16 with a temperature control device 24. This would have the advantage that the manufacturing process would be positively influenced by shortening the cooling times.

A shaping half-shell 12 of a shaping mould 40 with a part to be formed 38 is shown in FIG. 4. It is clear that the shaping mould, as previously described with reference to FIGS. 1 to 3, can comprise two shaping half-shells 12, 34 lying opposite one another, even if only one is shown in FIG. 4. The at least one shaping half-shell 12 is an element 16 made of a mineral material, for example the previously described bottom shaping element. As shown, the shaping mould 40, the element 16, preferably a previously described bottom shaping element 16, an inductor 14 shown as an inductor coil 33, and the part to be formed 38 comprise an electrically conductive layer 18 which at least partially covers a shaping surface 38a of the part to be formed 38. However, it is also conceivable that the electrically conductive layer 18 completely covers the part to be formed. The inductor 14 of the shaping mould 40 is configured to induce eddy currents in the electrically conductive layer 18 of the part to be formed 38. Furthermore, the part to be formed 38 may additionally or alternatively include particles in its interior which likewise heat up due to eddy currents induced by the inductor 14. It is clear that the part to be formed can also comprise an electrically conductive layer 18 and/or particles, in which eddy currents can be generated by the inductor 14, even when using the shaping device 10 described above.

Furthermore, it is conceivable that a heat-insulating layer 20, as previously described with reference to the shaping device 10, is arranged on the element 16 in the direction of the part to be formed 38. In addition, the element 16 can also all have functionalities that were previously described in relation to the bottom shaping element 16 of the shaping device 10, such as, for example, a sensor 28 and/or a temperature control device 24 and/or a heat-insulating layer 20 and/or a protective layer 30.

Two heat pipes 42 arranged in the bottom shaping element 16 for dissipating heat from the electrically conductive layer 18 are shown by way of example in FIGS. 1 to 3 in the shaping half-shells, each designated with the number 34. It is clear that one or more heat pipes 40 can also be arranged in the bottom shaping elements 16 of both shaping half-shells 12, 34. Preferably, in the perspective shown in FIGS. 1 to 3, an upper end of the heat pipe 40 is arranged on and/or adjacent to the electrically conductive layer 18. However, a contact element 42, preferably a plate contact 42, can also be cast into the bottom shaping element 16, which is in contact with the conductive layer 18 when the bottom shaping element 16 is connected to the top shaping element 17. A lower end of the heat pipe 40 in the perspective shown in FIGS. 1 to 3 points away from the electrically conductive layer 18 and can preferably be arranged adjacent to or in contact with the temperature control device 24. Furthermore, at least one heat pipe 42, preferably the plurality of heat pipes 42, is aligned with its longitudinal extent in the perpendicular direction.

1. Shaping device comprising
an inductor and
one or more shaping half-shells, at least one shaping half-shell comprising a bottom shaping element made of mineral material and a top shaping element,
wherein
the top shaping element
is releasably connected to the bottom shaping element or integrally formed with it,
covers at least partially an inner surface of the bottom shaping element and
comprises an electrically conductive layer,
and the inductor is set up to induce eddy currents in the electrically conductive layer.

2. Shaping device according to claim 1,
wherein the mineral material is ultra high strength concrete or polymer concrete.

3. Shaping device according to claim 1,
wherein the inductor is arranged in the bottom shaping element.

4. Shaping device according to claim 1,
wherein the electrically conductive layer is made of an electrically non-conductive material with electrically conductive elements arranged therein and/or by electrically conductive elements, which are arranged adjacent to a shaping surface of the top shaping element.

5. Shaping device according to claim 1,
wherein the shaping surface of the top shaping element and/or the electrically conductive layer of the top shaping element has/have a protective layer.

6. Shaping device according to claim 1,
wherein at least one sensor, for example at least one temperature sensor and/or one humidity sensor and/or one pressure sensor and/or one voltage sensor, is/are arranged in the bottom shaping element and/or that the top shaping element.

7. Shaping device according to claim 1,
wherein the bottom shaping element further comprises a temperature control device which is either arranged adjacent to an outer surface of the bottom shaping element facing away from the inner surface and/or is arranged in the volume of the bottom shaping element.

8. Shaping device according to claim 1,
wherein a heat-insulating layer is arranged between the bottom shaping element and the top shaping element, and/or in the bottom shaping element, and/or in the top shaping element.

9. Shaping device according to claim 9,
wherein the heat-insulating layer comprises one or more insert bodies, at least one of which forms a cavity,
and/or
the heat insulating layer comprises a preceramic paper.

10. Shaping device according to claim 1,
wherein the top shaping element further comprises a mineral material, and/or more than 80% of the top shaping element is essentially made of a metallic material, and that the heat-insulating layer is arranged between the bottom shaping element and the top shaping element, or it is integrally formed with one of said two elements.

11. Shaping device according to claim 1,
wherein the mineral material from which the bottom shaping element and/or the top shaping element is/are made comprises at least one additive which reduces the thermal conductivity of the mineral material.

12. Shaping device according to claim 1,
wherein the top shaping element further comprises a cooling element which is arranged on and/or adjacent to the electrically conductive layer,
and/or
comprises a heat pipe which is arranged at least partially in the bottom shaping element.

13. Shaping device according to claim 1,
wherein the shaping device comprises exactly two shaping half-shells which arrangeable opposite one another.

14. Shaping mould with a part to be formed,
wherein the shaping mould comprises:
one or more shaping half-shells, at least one shaping half-shell comprising an element made of a mineral material, and
an inductor,
wherein the part to be formed comprises:
an electrically conductive layer which at least partially covers a shaping surface of the part to be formed,
wherein the inductor of the shaping mould is set up to induce eddy currents in the electrically conductive layer of the part to be formed.

15. Method for heating a shaping surface of a top shaping element of a shaping half-shell, or a shaping surface of a part to be formed, wherein the shaping surface of the shaping half-shell or of the part to be formed is heated by means of an inductor which induces eddy currents in an electrically conductive layer arranged adjacent to the shaping surface.

16. Shaping device according to claim 1,
wherein the inductor is arranged in the bottom shaping element and cast into it.

17. Shaping device according to claim 4,
wherein the electrically conductive layer is made of an electrically non-conductive material with electrically conductive elements arranged therein, wherein the electrically conductive elements are electrically conductive particles and/or fibers, which are arranged adjacent to a shaping surface of the top shaping element.

18. Shaping device according to claim 4,
wherein the electrically conductive layer is made by electrically conductive elements, which are arranged adjacent to a shaping surface of the top shaping element and embedded in the top shaping element.

19. Shaping device according to claim 5,
wherein the electrically conductive layer and the protective layer are the same layer.

20. Shaping device according to claim 6,
wherein said at least one sensor is at least one temperature sensor and/or one humidity sensor and/or one pressure sensor and/or one voltage sensor, and wherein said at least one sensor is cast into one or both the bottom shaping element and the top shaping element.
